(19) United States
(12) Patent Application Publication
(10) Pub. No.: US 2024/0329214 A1
(43) Pub. Date: Oct. 3, 2024

(54) LIDAR CLEANING SYSTEM

(71) Applicant: Robert Bosch GmbH, Stuttgart (DE)

(72) Inventors: Zoltan Gyonyoru, Budapest (HU); Akos Hegyi, Mezöhegyes (HU); Bence Balint, Monor (HU); Gyorgy Szabo, Budapest (HU); Janos Simonovics, Dunaharaszti (HU); Mate Hornyak, Pakozd (HU); Peter Deak, Budapest (HU)

(21) Appl. No.: 18/611,902

(22) Filed: Mar. 21, 2024

(30) Foreign Application Priority Data
Mar. 27, 2023 (DE) 10 2023 202 752.6

(51) Int. Cl. G01S 7/497; B08B 1/34; G01S 17/931

(52) U.S. Cl. CPC G01S 7/497; B08B 1/34; G01S 2007/4977; G01S 17/931

(57) ABSTRACT

A LiDAR cleaning system includes a cleaning arm configured to clean a sensor surface of a LiDAR sensor by displacement of the cleaning arm. The system further includes a drive unit having at least two deflection elements and a belt element. The cleaning arm is detachably connected to the belt element. The drive unit is configured to displace the cleaning arm by rotation of the belt element about the at least two deflection elements to clean the sensor surface.

### BACKGROUND

The present invention relates to a LiDAR cleaning system and a vehicle.

There are currently a plurality of different solutions for cleaning sensor surfaces in vehicles. Due to the increasing number of sensor surfaces to be cleaned in the vehicle sector as well as the higher requirements for cleaning sensor surfaces as a result of autonomous driving, the need for innovative and reliable cleaning methods is constantly increasing.

Steady weight reduction in the vehicle area to reduce consumption and increasing competition create cost pressure so that cheaper and more efficient components for vehicles are more in demand.

### SUMMARY

The LiDAR cleaning system according to the invention has the advantage over the known system that a robust and reliable system is provided by means of the drive unit in order to clean the sensor surface. Furthermore, the service life of the LiDAR sensor can be increased, as the drive unit of the LiDAR cleaning system has a belt drive in particular, which is particularly low-wear, so that the LiDAR cleaning system has a particularly long service life.

According to the invention, this is achieved by the LiDAR cleaning system having a cleaning arm. The cleaning arm is designed to clean a sensor surface of a LiDAR sensor by means of a displacement. Furthermore, the LiDAR cleaning system has a drive unit, wherein the drive unit has at least two deflection elements and a belt element. The cleaning arm is also detachably connected to the belt element. The drive unit is also designed to move the cleaning arm by rotating the belt element around the at least two deflection rollers in order to clean the sensor surface.

In other words, the LiDAR cleaning system has a belt drive which is designed to move a cleaning arm in front of a sensor surface of the LiDAR sensor and thus clean the sensor surface. In particular, the cleaning arm has a preload which acts against the sensor surface and further improves the cleaning performance of the LiDAR cleaning system. By means of the drive unit and the friction arm arranged on it, it is not necessary to change the direction of rotation of the belt element, as the cleaning arm is arranged in such a way that it can change from a first displacement direction to a second displacement direction. The drive unit is designed to move the cleaning arm in a displacement direction so that the sensor surface of the LiDAR sensor is cleaned. In particular, the drive unit can have an electric motor or any other type of motor that drives the belt element or the belt drive. In particular, the motor can rotate in one direction, wherein the cleaning arm is arranged on the belt element in such a way that it can change direction. In particular, the cleaning arm has a lip that is designed to clean the sensor surface. Furthermore, the drive unit is designed to move the cleaning arm into a parking position in which the cleaning arm is protected from environmental influences such as rain and/or stone chipping. Furthermore, the drive unit comprises two deflection elements in particular, which can be arranged on the edge areas of the sensor surface.

Preferably, the cleaning arm is arranged on the belt element by means of a connecting element, the belt element having at least one pin which is designed to engage in a recess in the connecting element.

One advantage of this embodiment is that the pin can be used to form a simple form-fit and/or force-fit connection between the connecting element and the belt element. Furthermore, the connecting element can be arranged in a guide or similar, so that the cleaning arm in particular can be provided with an additional preload in order to clean the sensor surface.

Preferably, the connecting element has at least two recesses, the two recesses being arranged opposite a displacement axis on the connecting element, the pin on the belt element being designed in such a way that the pin engages in the first recess in a first displacement direction and the pin engages in the second recess in a second displacement direction.

One advantage of this embodiment is that the direction of rotation of the belt element around the transfer elements does not have to be changed if the displacement direction of the cleaning arm is to be changed. In particular, the pin can be arranged orthogonally to a displacement direction of the belt element. Furthermore, the connecting element has a first side to which the first recess is attached. Furthermore, the connecting element has a second side to which the second arrangement is attached. Furthermore, the first recess and the second recess are arranged essentially at a predetermined distance from one another, which corresponds approximately to the width of the belt element.

Further preferably, the connecting element has a groove, wherein the pin is arranged displaceably in the groove, wherein the pin is designed to change between a first position in the groove and a second position in the groove depending on a displacement direction.

An advantage of this embodiment is that the pin is arranged in a predetermined guide with the aid of the groove, so that the reliability of the LiDAR cleaning system can be further increased. In particular, the connecting element can have a groove or a tongue and groove or another form of recess in which a pin, in particular of the connecting element, can be arranged. The pin can remain in a first position in the groove while the connecting element is transported by the drive unit in a first displacement direction. When the connecting element reaches the deflection element, the pin toggles from the first position to the second position so that the connecting element can be displaced in a second displacement direction.

Preferably, the LiDAR cleaning system has a rotary unit, wherein the rotary unit has a bearing element on which the cleaning arm can be arranged, wherein at least one gripping element is rotatably arranged on the bearing element, wherein the gripping element is designed to form a force-fit and/or form-fit connection with the belt element, wherein the rotary unit is designed to change a displacement direction of the cleaning arm when the gripping element reaches one of the two deflection elements.

One advantage of this embodiment is that a fixed connection can be formed between the cleaning arm and the belt element by means of the rotary unit, so that the reliability of the LiDAR cleaning system can be further increased. Furthermore, the cleaning arm can be arranged on the bearing element of the rotary unit, which is, for example, a ball bearing or similar. Furthermore, a gripping element can be arranged on the bearing element, which is designed to form a form-fit and/or force-fit connection with the belt element. For example, the gripping element can be designed as a type of bar that can engage in a recess in the belt element. As soon as the gripping element on the belt element forms a force-fit and/or form-fit connection, the drive unit transports the gripping element towards one of the deflection elements. As soon as the gripping element reaches the deflection element, the form-fit and/or force-fit connection is not released, but the gripping element is rotated around the deflection element by means of the bearing element so that the gripping element follows the same path as the belt element. The gripping element is rotated around the deflection element until the gripping element is essentially orthogonal to the belt element and then moves away from the deflection element again.

Preferably, the rotary unit has at least one stopper element, which is designed to rotate the bearing element by means of the force-fit and/or form-fit connection between the gripping element and the belt element in order to change the displacement direction.

One advantage of this embodiment is that the stopper element can be used to prevent the rotary unit on the belt element from tilting when the gripping element is rotated by means of the bearing element. For example, the stopper element can be designed as a kind of bar or similar, which temporarily holds and/or orients the rotary unit on the deflection element.

Further preferably, one of the at least two deflection elements has a first side and a second side, wherein the gripping element toggles from the first side to the second side by means of the rotation of the bearing element when it reaches the at least one deflection element.

One advantage of this embodiment is that the direction of rotation of the belt element does not have to be changed when the gripping element is switched from the first to the second side, so that the control technology of the LiDAR cleaning system can be significantly simplified.

Further preferably, the belt element has a first plurality of recesses on a first flank of the belt element.

One advantage of this embodiment is that any number of cleaning arms can be attached to the belt element. In particular, a cleaning arm can be arranged at each or only at a part of the plurality of recesses.

Further preferably, the belt element has a second plurality of recesses on a second flank of the belt element.

One advantage of this embodiment is that a gripping element of the rotary unit can be arranged on both sides of the belt element.

A further aspect of the invention relates to a vehicle comprising a LiDAR sensor and a LiDAR cleaning system as described above and below.

### BRIEF DESCRIPTION OF THE DRAWINGS

Exemplary embodiments of the invention are described in detail in the following with reference to the accompanying drawing. In the drawings:

FIG. 1 a LiDAR cleaning system according to one embodiment,

FIG. 2 a LiDAR cleaning system according to one embodiment,

FIGS. 3a, 3b a LiDAR cleaning system according to one embodiment,

FIGS. 4a through 4c a LiDAR cleaning system according to one embodiment,

FIGS. 5a through 5c a LiDAR cleaning system according to one embodiment,

FIG. 6 a LiDAR cleaning system,

FIGS. 7a through 7c a LIDAR cleaning system according to one embodiment,

FIG. 8 shows a vehicle according to one embodiment.

### DETAILED DESCRIPTION

Preferably, all identical components, elements, and/or units are provided with the same reference symbols in all figures.

FIG. 1 shows a LiDAR cleaning system according to one embodiment.

The LiDAR cleaning system 10 is arranged on a LiDAR sensor 100. The LiDAR sensor 100 has a sensor surface 102 which is designed to send and/or receive signals. The LiDAR cleaning system also comprises a cleaning arm 12. The cleaning arm 12 is designed to clean the sensor surface 102 by means of a displacement 14.

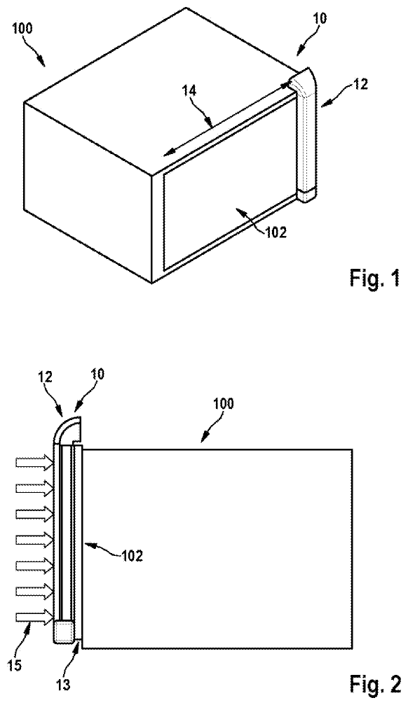

FIG. 2 shows a cleaning system 10 according to one embodiment. The cleaning system is arranged on the LiDAR sensor 100, which has a sensor surface 102. The LiDAR cleaning system 10 has a cleaning arm 12, which has a lip 13. The cleaning arm is also preferably designed to press the lip 13 against the sensor surface 102 by means of a preload 15 in order to clean it.

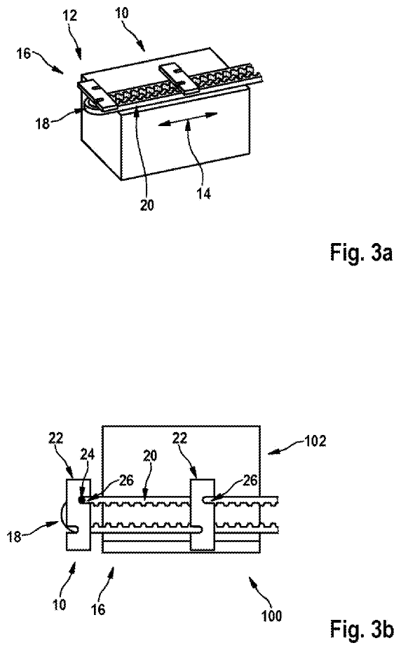

FIG. 3a shows a LiDAR cleaning system 10, which comprises a cleaning arm 12. The cleaning arm 12 is attached to a drive unit 16 of the LiDAR cleaning system 10. The drive unit 16 comprises at least one deflection element 18, which is designed to deflect a belt element 20 so that a displacement direction 40 of the cleaning arm 12 can be changed. Furthermore, the cleaning arm 12 can be displaced 14 by means of the drive unit 16 in order to clean the sensor surface 102.

FIG. 3b shows a top view of the LiDAR cleaning system 10 from FIG. 3a. A connecting element 22 is arranged on the belt element 20, which has at least one recess 26. In particular, the cleaning arm 12 can be arranged on the connecting element 22. Furthermore, the belt element 20 comprises a pin 24 which engages in the recess 26 of the connecting element 22 in order to be able to displace the cleaning arm 12 towards the sensor surface 102.

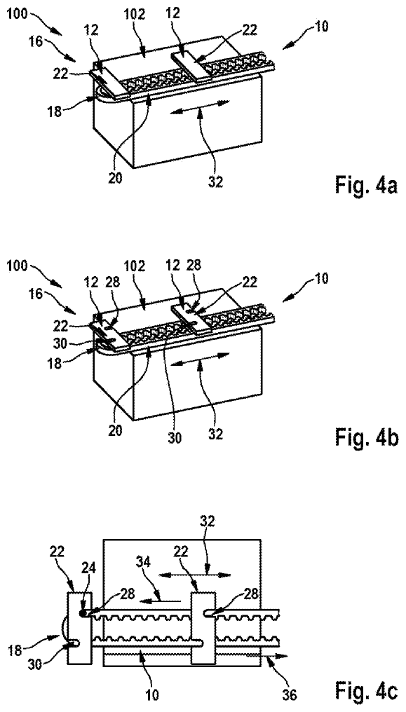

FIG. 4a shows an embodiment of the LiDAR cleaning system 10. The LiDAR cleaning system 10 is arranged on a LiDAR sensor 100, which has a sensor surface 102. The sensor surface 102 can be cleaned by means of the cleaning arm 12, which is arranged on the connecting element 22. The drive unit 16 of the LiDAR cleaning system 10 is designed to move the cleaning arm 12 along a displacement axis 32 relative to the sensor surface 102. The drive unit 16 comprises a deflection element 18 and a belt element 20. In particular, the belt element 20 is tensioned around two deflection elements 18 to form a type of belt drive.

FIG. 4b shows the embodiment of FIG. 4a, with the cleaning arm 12 removed from the connecting element 22. The connecting element 22 has a first recess 28 and a second recess 30. The pin 24 can engage in both the first recess 28 and the second recess 30. Furthermore, the drive unit 16 is designed to move the connecting element 22 by means of the belt element 20 and the deflection rollers 18.

FIG. 4c shows a top view of the embodiment of the LiDAR cleaning system 10 of FIGS. 4a and 4b. The connecting element 22 has a first recess 28, in which the pin 24 engages in order to displace the cleaning arm 12 or the connecting element 22 along a first displacement direction 34. The deflection roller 18 is designed to deflect the belt element 20 so that the pin 24 toggles from a first displacement direction 34 to a second displacement direction 36. Furthermore, the pin 24 is designed to engage in the second recess 30 of the connecting element 20 when the pin 24 moves in the second displacement direction 36 by means of the belt element 20.

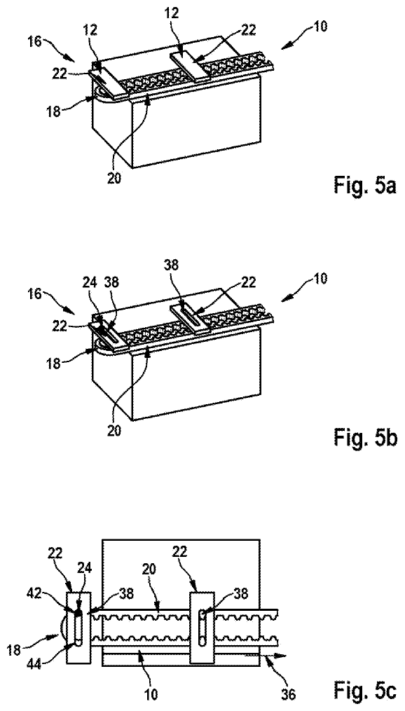

FIG. 5a shows an embodiment of the LiDAR cleaning system 10. The LiDAR cleaning system 10 comprises a drive unit 16. The drive unit 16 has a deflection element 18, in particular a deflection roller, and a belt element 20, which is a belt or a chain, for example. In particular, the cleaning arm 12 can be arranged on the belt element 20 by means of a connecting element 22.

FIG. 5b shows a perspective view of the cleaning system 10 of FIG. 5a, in which the cleaning arm 12 has been detached from the connecting element 22. The connecting element 22 has a groove 38 in which a pin 24 is arranged. The pin 24 is arranged displaceably in the groove 38 of the connecting element 22 so that the pin 24 can change sides when it is deflected by means of the deflecting element 18.

FIG. 5c shows a top view of the LiDAR cleaning system 10 of FIGS. 5a and 5b. The connecting element 22 has a groove 38. A pin 24 is positioned in the groove 38, which is arranged on the belt element 20. In this case, the pin 24 can change from a first position 42 and a second position 44 of the groove 38 when the displacement direction of the cleaning arm 122 is changed.

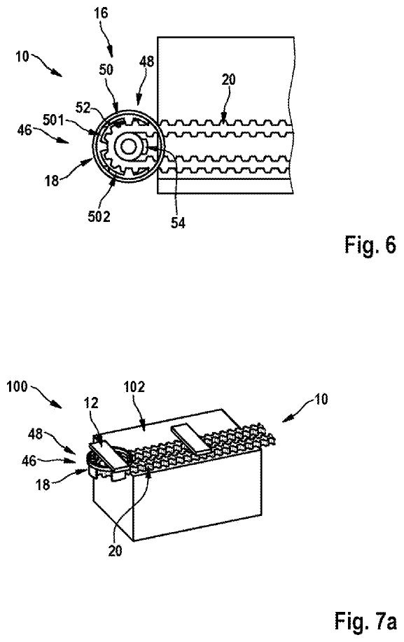

FIG. 6 shows an embodiment of the LiDAR cleaning system 10. The LiDAR cleaning system 10 comprises a drive unit 16. Furthermore, the LiDAR cleaning system comprises a rotary unit 46. The rotary unit 46 comprises a bearing element 48. In particular, the cleaning arm 12 can be arranged on the bearing element 48, wherein in particular a connecting element 22 can be arranged between the bearing element 48 and the cleaning arm 12. A gripping element 50 is also preferably arranged on the bearing element 48. The gripping element 50 forms a form-and/or force-fit connection 52 with the belt element 20. When the rotary unit 46 reaches a deflection element 18, the gripping element 50 is rotated in relation to the cleaning arm 12. The gripping element 50 has an intermediate position 501 and an end position 502 of rotation. In the end position 502 of the rotation, the gripping element 50 moves in a further displacement direction.

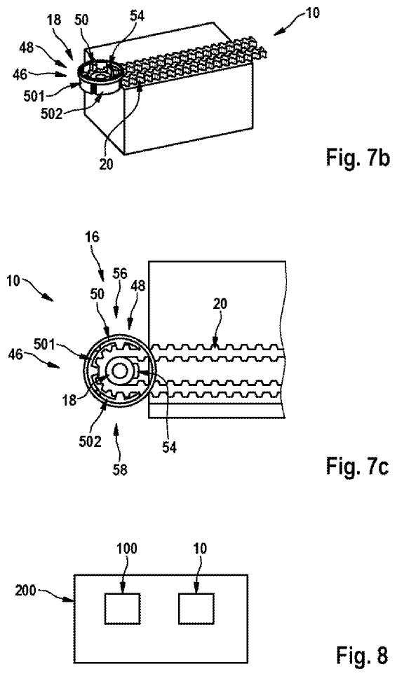

FIG. 7a shows a LiDAR cleaning system 10, which has a cleaning arm 12. The cleaning arm 12 is designed to clean the sensor surface 102 of the LiDAR sensor 100. The cleaning arm 12 is arranged on the rotary unit 46, in particular on a bearing element 48 of the rotary unit 46. The cleaning arm 12 can be displaced towards the sensor surface 102 by means of the belt element 20.

FIG. 7b shows a perspective view of the LiDAR cleaning system 10 as shown in FIG. 7a. The LiDAR cleaning system 10 comprises a rotary unit 46. The rotary unit 46 has a bearing element 48, on which the cleaning arm 12 in particular can be arranged. In particular, a gripping element 50 is arranged on the bearing element 48. The gripping element 50 is transported in the direction of a deflection element 18 by means of the belt element 20. When the rotary unit reaches the deflection element 18, the stopper element 54 initiates a pivoting and/or rotating process of the gripping element 50. The gripping element 50 is rotated into an intermediate position 501 and an end position 502 by means of the movement of the belt element. In the end position 502, the rotary unit 46 is transported away from the deflection element 18 by means of the belt element 20.

FIG. 7c shows a top view of the LiDAR cleaning system 10 as shown in FIGS. 7a and 7b. The LiDAR cleaning system 10 has a drive unit 16. Furthermore, the LiDAR cleaning system 10 comprises a rotary unit 46. The belt element 20 is fixed to the bearing element 48 by means of a gripping element 50. Furthermore, the deflection element 18 has a first side 56 and a second side 58. When the rotary unit 46 is transported to the deflection element 18 by means of the belt element 20, the gripping element 50 is located on the first side 56. As soon as the rotary unit 46 is in contact with the deflection element 18, the gripping element 50 is displaced into an intermediate position 501 and then into an end position 502 by means of the belt element 20, wherein the end position 502 is located on the second side 58.

FIG. 8 shows a vehicle 200 with a LiDAR sensor 100 and a LiDAR cleaning system 10.

1. A LIDAR cleaning system (10) comprising:
a cleaning arm (12) configured to clean a sensor surface (102) of a LiDAR sensor (100) by displacement (14) of the cleaning arm (12), and
a drive unit (16), wherein the drive unit (16) has at least two deflection elements (18) and a belt element (20), wherein the cleaning arm (12) is detachably connected to the belt element (20), wherein the drive unit (16) is configured to displace the cleaning arm (12) by rotation of the belt element (20) about the at least two deflection elements (18) to clean the sensor surface (102).

2. The LiDAR cleaning system (10) according to claim 1, wherein the cleaning arm (12) is arranged on the belt element (20) by a connecting element (22), wherein the belt element (20) has a pin (24) which is configured to engage in a recess (26) of the connecting element (22).

3. The LiDAR cleaning system (10) according to claim 2, wherein the connecting element (22) has at least two recesses (28, 30), wherein the two recesses (28, 30) are arranged opposite a displacement axis (32) on the connecting element (22), wherein the pin (24) on the belt element (20) is designed such that the pin (24) engages in a first displacement direction (34) in the first recess (28) and the pin (24) engages in a second displacement direction (36) in the second recess (30).

4. The LiDAR cleaning system (10) according to claim 2, wherein the connecting element (22) has a groove (28), wherein the pin (24) is arranged displaceably in the groove (38), wherein the pin (24) is designed to change between a first position (42) in the groove (38) and a second position (44) in the groove (38) depending on a displacement direction (40).

5. The LiDAR cleaning system (10) according to claim 1, wherein the LiDAR cleaning system (10) has a rotary unit (46), wherein the rotary unit (46) has a bearing element (48) on which the cleaning arm (12) can be arranged, wherein a gripping element (50) is rotatably arranged on the bearing element (48), wherein the gripping element (50) is configured to form a force-fit and/or form-fit connection (42) with the belt element (20), wherein the rotary unit (46) is configured to change a displacement direction (40) of the cleaning arm (12) when the gripping element (50) reaches one of the at least two deflection elements (18).

6. The LiDAR cleaning system (10) according to claim 5, wherein the rotary unit (46) comprises a stopper element (54) configured to rotate the bearing element (48) by the force-fit and/or form-fit connection (52) between the gripping element (50) and the belt element (20) to change the displacement direction (40).

7. The LiDAR cleaning system (10) according to claim 5, wherein one of the at least two deflection elements (18) has a first side (56) and a second side (58), wherein the gripping element (50) toggles from the first side (56) to the second side (58) via rotation of the bearing element (48) when reaching the one of the at least two deflection elements (18).

8. The LiDAR cleaning system (10) according to claim 1, wherein the belt element (20) comprises a first plurality of recesses on a first flank of the belt element (20).

9. The LiDAR cleaning system (10) according to claim 8, wherein the belt element (20) comprises a second plurality of recesses on a second flank of the belt element (20).

10. A vehicle (200) comprising a LiDAR sensor (100) and a LiDAR cleaning system (10) according to claim 1.

11. The LiDAR cleaning system (10) according to claim 6, wherein one of the at least two deflection elements (18) has a first side (56) and a second side (58), wherein the gripping element (50) toggles from the first side (56) to the second side (58) via rotation of the bearing element (48) when reaching the one of the at least two deflection elements (18).
